(19) United States
(12) Patent Application Publication
(10) Pub. No.: US 2015/0081041 A1
(43) Pub. Date: Mar. 19, 2015

(54) OUTPUT APPARATUS AND DIAGNOSIS METHOD THEREFOR

(71) Applicants: KABUSHIKI KAISHA TOSHIBA, Tokyo (JP); TOSHIBA MITSUBISHI-ELECTRIC INDUSTRIAL SYSTEMS CORPORATION, Tokyo (JP)

(72) Inventors: Fumitaka Mouri, Tokorozawa Saitama (JP); Makoto Toko, Tokorozawa Saitama (JP); Hiroshi Nakatani, Tokyo (JP); Naoya Ohnishi, Tokyo (JP); Akira Nojima, Tokyo (JP)

(21) Appl. No.: 14/472,813

(22) Filed: Aug. 29, 2014

(30) Foreign Application Priority Data
Sep. 18, 2013 (JP) 2013-193473

(51) Int. Cl. G05B 9/02

(52) U.S. Cl. CPC G05B 9/02
USPC 700/14

(57) ABSTRACT

According to one embodiment, there is provided an output apparatus including a signal control unit configured to set a signal from a second output element in an OFF state at a timing earlier than a predetermined timing by the response time of a second load, and set signals from a first output element and the second output element in an ON state, and signals from a first interruption element and a second interruption element in an OFF state at a timing earlier than the predetermined timing by the response time of a first load. The output apparatus includes a diagnosis unit configured to diagnose, at the predetermined timing, whether the first and second interruption elements are in a normal state or a failure state, based on a signal from the first and second digital output circuits.

### CROSS-REFERENCE TO RELATED APPLICATIONS

This application is based upon and claims the benefit of priority from prior Japanese Patent Applications No. 2013-193473, filed Sep. 18, 2013, the entire contents of which are incorporated herein by reference.

### FIELD

Embodiments described herein relate generally to an output apparatus and a diagnosis method therefor.

### BACKGROUND

In recent years, for the manufacturers and suppliers of apparatuses, an international functional safety standard has been established as the IEC61508 standard “Functional Safety of Electrical/Electronic/Programmable Electronic Safety-related Systems” of the IEC (International Electrotechnical Commission). Furthermore, in a functional safety system for a specific industry, a derivative standard for a specific application purpose has been stipulated. For example, with respect to a safety instrumentation system, IEC61511 has been stipulated for designers, integrators, and users of the system as the international process application standard.

In these standards, safety in the lifecycle of design, maintenance, and disposition of a system is assessed, and the SIL (Safety Integrity Level), which is the required level of risk reduction, is defined as a quantitative assessment scale.

The safety instrumentation system required to achieve a high SIL needs to detect a failure of a digital output circuit. It is necessary to diagnose a target digital output circuit not only at the time of start of the system but also during the operation of the system. If a failure is detected, it is necessary to cause the output of the system to transit to a safe state.

In connection from a digital output circuit including an output interruption circuit to an input circuit serving as a control apparatus (load), a failure of an output element in the output interruption circuit is diagnosed within the non-response time of the control apparatus.

Since, however, the non-response times of control apparatuses are different from each other, it is necessary to perform failure diagnosis by changing the diagnosis timing for each digital output circuit according to the response characteristic of a control apparatus connected to the digital output circuit.

To perform failure diagnosis of an interruption element and output element, therefore, it is necessary to control each of the interruption element and the output element. As the number of control apparatuses increases, the device cost and the part implementation area respectively increase.

### BRIEF DESCRIPTION OF THE DRAWINGS

FIG. 1 is a circuit diagram showing an example of the arrangement of the digital output circuits of an output apparatus according to the first embodiment;

FIG. 2 is a view for explaining an example of the overall operation at timings of element diagnosis by the output apparatus according to the first embodiment.

FIG. 3 is a view for explaining an example of an output element OFF diagnosis operation by the output apparatus according to the first embodiment;

FIG. 4 is a flowchart illustrating an example of a procedure for OFF diagnosis of the first output element 41 and second output element 43 by the output apparatus according to the first embodiment;

FIG. 5 is a view for explaining an example of an interruption element OFF diagnosis operation by the output apparatus according to the first embodiment;

FIG. 6 is a flowchart illustrating an example of a procedure for OFF diagnosis of the first interruption element and second interruption element by the output apparatus according to the first embodiment;

FIG. 7 is a view for explaining an example of an interruption element diagnosis operation by the output apparatus according to the first embodiment when the various output signals are ON;

FIG. 8 is a circuit diagram showing an example of the arrangement of the digital output circuits of the output apparatus according to the second embodiment;

FIG. 9 is a view for explaining an example of an output element diagnosis operation by the output apparatus according to the second embodiment;

FIG. 10 is a flowchart illustrating an example of a procedure for OFF diagnosis of the first output element and second output element by the output apparatus according to the second embodiment;

FIG. 11 is a view for explaining an example of an interruption element diagnosis operation by the output apparatus according to the second embodiment;

FIG. 12 is a flowchart illustrating an example of a procedure for OFF diagnosis of the first interruption element and second interruption element by the output apparatus according to the second embodiment; and

FIG. 13 is a circuit diagram showing an example of the arrangement of a conventional interruption/output element diagnosis circuit.

### DETAILED DESCRIPTION

In general, according to one embodiment, there is provided an output apparatus connected to a first load and a second load whose response time to a signal is longer than that of the first load. The output apparatus includes a first digital output circuit including a first output element configured to output a signal to the first load, and a first interruption element connected to the first output element. The output apparatus includes a second digital output circuit including a second output element configured to output a signal to the second load, and a second interruption element connected to the second output element. The output apparatus includes a single driving circuit for an interruption element, configured to drive the first interruption element and the second interruption element collectively. The output apparatus includes a signal control unit configured to set a signal from the second output element in an OFF state at a timing earlier than a predetermined timing by the response time of the second load, and set signals from the first output element and the second output element in an ON state, and signals from the first interruption element and the second interruption element in an OFF state at a timing earlier than the predetermined timing by the response time of the first load The output apparatus includes a diagnosis unit configured to diagnose, at the predetermined timing, whether the first interruption element is in a normal state or a failure state, based on a signal from the first digital output circuit, and diagnose, at the predetermined timing, whether the second interruption element is in a normal state or a failure state, based on a signal from the second digital output circuit.

Embodiments will be described below with reference to the accompanying drawings.

For easy understanding of the embodiments, the arrangement of the digital output circuits of a conventional output apparatus will be explained first.

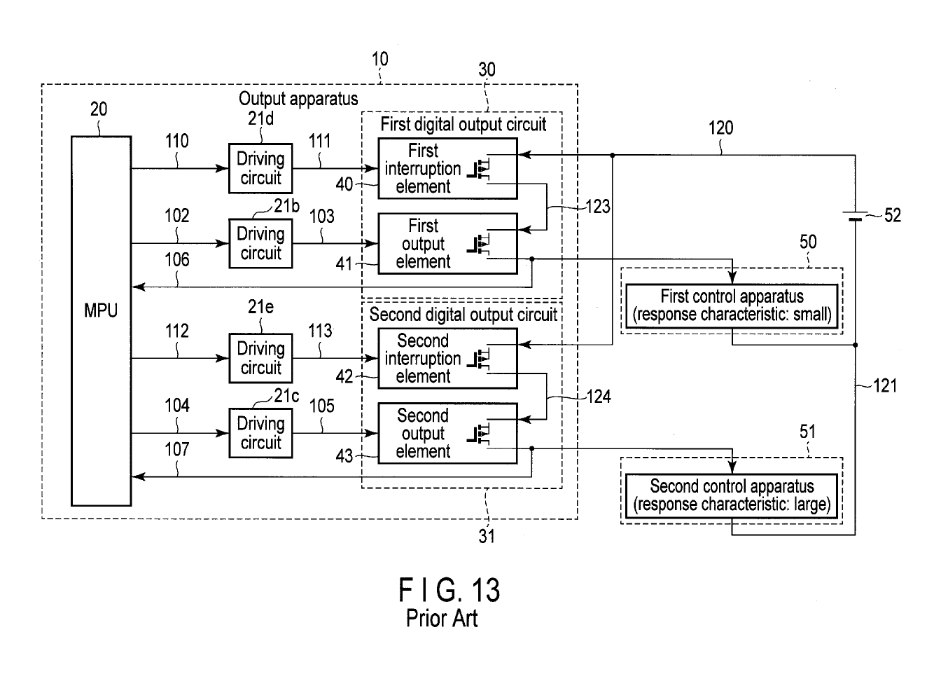

FIG. 13 is a circuit diagram showing an example of the arrangement of a conventional interruption/output element diagnosis circuit.

An output apparatus 10 includes a first digital output circuit 30 and a second digital output circuit 31. The output apparatus 10 has a function of diagnosing the first digital output circuit 30 and the second digital output circuit 31.

The first digital output circuit 30 will be described.

The first digital output circuit 30 includes a MOSFET (field effect transistor) of a first output element 41. The MOSFET of the first output element 41 operates as a switching element for driving a first control apparatus 50 serving as a first load. The source of the first output element 41 is connected to an MPU 20 and the input terminal of the first control apparatus 50. The MPU 20 monitors the output state of the first digital output circuit 30.

The first digital output circuit 30 includes a MOSFET of a first interruption element 40. The MOSFET of the first interruption element 40 operates as a switching element for interrupting the first digital output circuit 30. The source of the first interruption element 40 is connected to the drain of the first output element 41 via a first interruption element-first output element connection line 123. The gate of the first output element 41 is connected to a driving circuit 21b for the first output element 41.

The drain of the first interruption element 40 is connected to the positive side of an external power supply apparatus 52 via a positive line 120 of the external power supply apparatus 52. The gate of the first interruption element 40 is connected to a driving circuit 21d for the first interruption element 40. As will be described later, the driving circuit 21d also serves as a driving circuit for a second interruption element 42.

The driving circuit 21b for the first output element 41 and the driving circuit 21d for the first interruption element 40 are connected to the MPU 20 for driving the first output element 41 and the first interruption element 40.

The second digital output circuit 31 will be described next.

The second digital output circuit 31 includes a MOSFET of a second output element 43. The MOSFET of the second output element 43 operates as a switching element for driving a second control apparatus 51 serving as a second load. The source of the second output element 43 is connected to the MPU 20 and the input terminal of the second control apparatus 51. The MPU 20 monitors the output state of the second digital output circuit 31.

As the first control apparatus 50 connected to the first output element 41 of the first digital output circuit 30, a control apparatus having a quick response characteristic, for example, a small time constant (tcr1<tcr2) is used.

As the second control apparatus 51 connected to the second output element 43 of the second digital output circuit 31, a control apparatus having a response characteristic slower than that of the first control apparatus 50, for example, a large time constant (tcr2>tcr1) is used.

The second digital output circuit 31 includes a MOSFET of the second interruption element 42. The MOSFET of the second interruption element 42 operates as a switching element for interrupting the second digital output circuit 31. The source of the second interruption element 42 is connected to the drain of the second output element 43 via a second interruption element-second output element connection line 124. The gate of the second output element 43 is connected to a driving circuit 21c for the second output element 43. The gate of the second interruption element 42 is connected to a driving circuit 21e for the second interruption element 42.

The driving circuit 21c for the second output element 43 and the driving circuit 21e for the second interruption element 42 are connected to the MPU 20 for driving the second output element 43 and the second interruption element 42.

Furthermore, the output terminals of the first control apparatus 50 and second control apparatus 51 are connected to the negative side of the external power supply apparatus 52 via a negative line 121 of the external power supply apparatus 52. The positive side of the external power supply apparatus 52 is connected to the drain of the second interruption element 42.

As described above, in the conventional arrangement shown in FIG. 13, the MPU 20 drives the first interruption element 40 and the second interruption element 42 via the different driving circuits 21d and 21e, respectively.

The MPU 20 outputs a first interruption element control signal 110 for controlling the first interruption element 40 to the driving circuit 21d for the first interruption element 40. The driving circuit 21d outputs a first interruption signal (first interruption element driving signal) 111 to the first interruption element 40.

If the first interruption element 40 is normal, when the first interruption signal 111 is set in the ON state, the first interruption element 40 is set in the ON state. Furthermore, if the first interruption element 40 is normal, when the first interruption signal 111 is set in the OFF state, the first interruption element 40 is set in the OFF state.

The MPU 20 outputs a first output element control signal 102 for controlling the first output element 41 to the driving circuit 21b for the first output element 41. The driving circuit 21b outputs a first output signal (first output element driving signal) 103 to the first output element 41.

If the first output element 41 is normal, when the first output signal 103 is set in the ON state, the first output element 41 is set in the ON state. Furthermore, if the first output element 41 is normal, when the first output signal 103 is set in the OFF state, the first output element 41 is set in the OFF state.

The MPU 20 outputs a second interruption element control signal 112 for controlling the second interruption element 42 to the driving circuit 21e for the second interruption element 42. The driving circuit 21e outputs a second interruption signal (second interruption element driving signal) 113 to the second interruption element 42.

If the second interruption element 42 is normal, when the second interruption signal 113 is set in the ON state, the second interruption element 42 is set in the ON state. Furthermore, if the second interruption element 42 is normal, when the second interruption signal 113 is set in the OFF state, the second interruption element 42 is set in the OFF state.

The MPU 20 outputs a second output element control signal 104 for controlling the second output element 43 to the driving circuit 21c for the second output element 43. The driving circuit 21c outputs a second output signal (second output element driving signal) 105 to the second output element 43.

If the second output element 43 is normal, when the second output signal 105 is set in the ON state, the second output element 43 is set in the ON state. Furthermore, if the second output element 43 is normal, when the second output signal 105 is set in the OFF state, the second output element 43 is set in the OFF state.

Based on a first output diagnosis signal 106 and a second output diagnosis signal 107 according to the signal control of the various elements, the MPU 20 diagnoses whether each of various elements is in a normal state (an ON/OFF signal can be output) or a failure state (no OFF signal can be output). Diagnosis of whether each of various elements can output an ON signal may be referred to as ON diagnosis. Diagnosis of whether each of various elements can output an OFF signal may be referred to as OFF diagnosis.

That is, with the conventional arrangement, it is necessary to diagnose the first interruption element 40 and the second interruption element 42 individually in accordance with the response characteristic of each control apparatus. Therefore, both the driving circuit 21d for the first interruption element 40 and the driving circuit 21e for the second interruption element 42 are required.

When the output is ON during control output, the MPU 20 performs ON diagnosis for the first output element 41, second output element 43, first interruption element 40, and second interruption element 42 collectively.

That is, the MPU 20 performs OFF diagnosis of the first output element 41 and second output element 43, OFF diagnosis of the first interruption element 40 and second interruption element 42, and ON diagnosis of the first output element 41, second output element 43, first interruption element 40, and the second interruption element 42. With this processing, the MPU 20 performs ON/OFF failure diagnosis of each element.

### First Embodiment

The first embodiment will now be described.

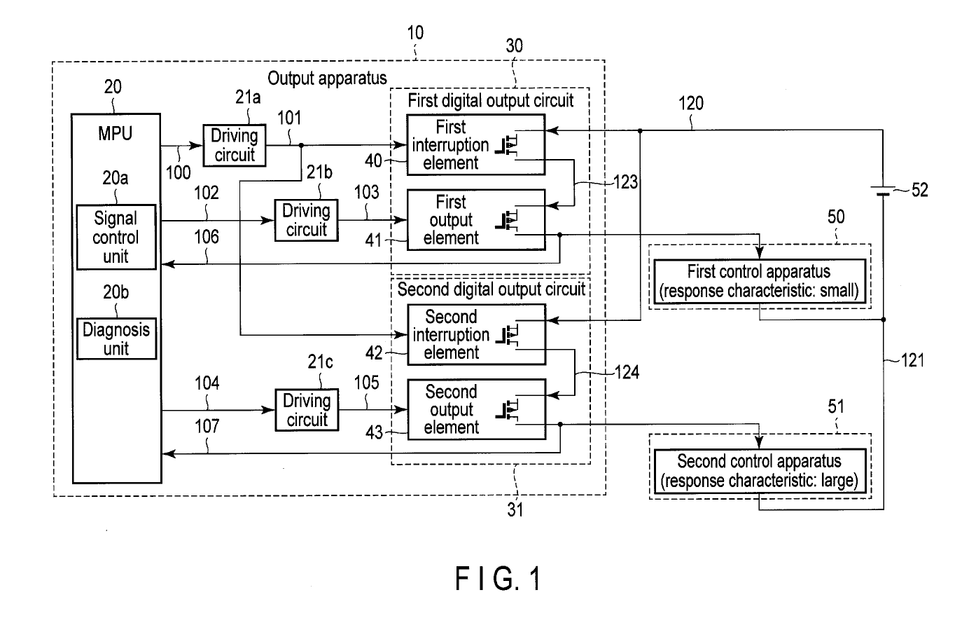

FIG. 1 is a circuit diagram showing an example of the arrangement of the digital output circuits of an output apparatus according to the first embodiment.

Of components shown in FIG. 1, components different from those shown in FIG. 13 will be mainly explained.

In the arrangement shown in FIG. 1, instead of respectively providing the driving circuits 21d and 21e for the first interruption element 40 and the second interruption element 42 as shown in FIG. 13, one driving circuit 21a common to a first interruption element 40 and a second interruption element 42 is provided. The driving circuit 21a is connected to the gate of the first interruption element 40 and that of the second interruption element 42. This common driving circuit will be referred to as the driving circuit 21a for each interruption element, as needed.

An MPU 20 includes a signal control unit 20a for controlling signals to various elements, and a diagnosis unit 20b for diagnosing, based on a first output diagnosis signal 106 and second output diagnosis signal 107 according to the signal control, whether each of the various elements is in the normal or failure state.

The driving circuit 21a for each interruption element is configured to output a first/second interruption signal (interruption element driving signal) 101 as a signal common to the first interruption element 40 and the second interruption element 42 in accordance with an interruption element control signal 100 from the signal control unit 20a of the MPU 20.

If the first interruption element 40 and the second interruption element 42 are normal, when the first/second interruption signal 101 is set in the ON state, the first interruption element 40 and the second interruption element 42 are set in the ON state. Furthermore, if the first interruption element 40 and the second interruption element 42 are normal, when the first/second interruption signal 101 is set in the OFF state, the first interruption element 40 and the second interruption element 42 are set in the OFF state.

As described above, in this embodiment, the first interruption element 40 and second interruption element 42 are connected to the one driving circuit 21a for the interruption elements; however, it is possible to reduce the number of driving circuits, as compared with the arrangement shown in FIG. 13.

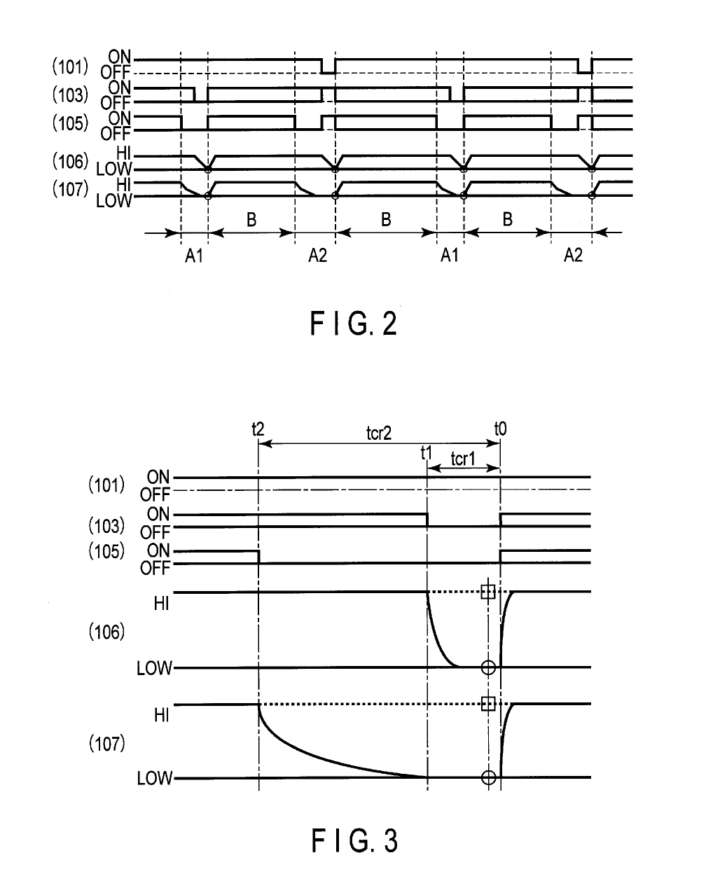

FIG. 2 is a view for explaining an example of the overall operation at timings of element diagnosis by the output apparatus according to the first embodiment. Referring to FIG. 2, reference symbol A1 denotes an output element diagnosis period; A2, an interruption element diagnosis period; and B, a control output period.

FIG. 2 shows timings at which OFF diagnosis is performed for a first output element 41, a second output element 43, the first interruption element 40, and the second interruption element 42, respectively.

Control of various signals for performing OFF diagnosis of the first output element 41 and second output element 43 will be described.

Before a predetermined timing at which OFF diagnosis is performed for the first output element 41 and the second output element 43, the signal control unit 20a of the MPU 20 sets the first/second interruption signal 101 in the ON state.

To set the first/second interruption signal 101 in the ON state, the signal control unit 20a of the MPU 20 outputs the interruption element control signal 100 for setting the first/second interruption signal 101 in the ON state to the driving circuit 21a for each interruption element. Then, the driving circuit 21a outputs the first/second interruption signal 101 set in the ON state to the first interruption element 40 and the second interruption element 42. The same applies to the processing of outputting a signal for setting the first/second interruption signal 101 in the OFF state, except that the ON/OFF state is different.

When the predetermined timing at which OFF diagnosis is performed for the first output element 41 and the second output element 43 comes, the signal control unit 20a of the MPU 20 outputs signals for setting a first output signal 103 and a second output signal 105 in the OFF state to the driving circuits 21b and 21c within the response times of a first control apparatus 50 and second control apparatus 51, respectively, while the first/second interruption signal 101 is in the ON state.

To set the first output signal 103 in the OFF state, the signal control unit 20a of the MPU 20 outputs a first output element control signal 102 for setting the first output signal 103 in the OFF state to a driving circuit 21b for the first output element 41. Then, the driving circuit 21b outputs the first output signal 103 set in the OFF state to the first output element 41. The same applies to processing of outputting a signal for setting the first output signal 103 in the ON state, except that the ON/OFF state is different.

To set the second output signal 105 in the OFF state, the signal control unit 20a of the MPU 20 outputs a second output element control signal 104 for setting the second output signal 105 in the OFF state to a driving circuit 21c for the second output element 43. Then, the driving circuit 21c outputs the second output signal 105 set in the OFF state to the second output element 43. The same applies to the processing of outputting a signal for setting the second output signal 105 in the ON state, except that the ON/OFF state is different.

The diagnosis unit 20b of the MPU 20 performs OFF diagnosis of the first output element 41 by determining the voltage level of the first output diagnosis signal 106 when the driving circuit 21b is caused to set the first output signal 103 in the OFF state.

The diagnosis unit 20b of the MPU 20 performs OFF diagnosis of the second output element 43 by determining the voltage level of the second output diagnosis signal 107 when the driving circuit 21c is caused to set the second output signal 105 in the OFF state.

Control of various signals for performing OFF diagnosis of the first interruption element 40 and second interruption element 42 will be described next.

Before a predetermined timing at which OFF diagnosis is performed for the first interruption element 40 and the second interruption element 42, the signal control unit 20a of the MPU 20 causes the driving circuits 21b and 21c to respectively output the first output signal 103 and the second output signal 105 while maintaining the ON or OFF state set at the time immediately preceding control output.

When the predetermined timing at which OFF diagnosis is performed for the first interruption element 40 and the second interruption element 42 comes, the signal control unit 20a of the MPU 20 outputs signals for setting the first output signal 103 and the second output signal 105 in the ON state to the driving circuits 21b and 21c, respectively. At this timing, the signal control unit 20a of the MPU 20 outputs, to the driving circuit 21a, a signal for setting the first/second interruption signal 101 in the OFF state within the response times of the first control apparatus 50 and second control apparatus 51.

The diagnosis unit 20b of the MPU 20 performs OFF diagnosis of the first interruption element 40 by determining the voltage level of the first output diagnosis signal 106 when the first/second interruption signal 101 is set in the OFF state. The diagnosis unit 20b of the MPU 20 performs OFF diagnosis of the second interruption element 42 by determining the voltage level of the second output diagnosis signal 107 when the first/second interruption signal 101 is set in the OFF state.

FIG. 3 is a view for explaining an example of an output element OFF diagnosis operation by the output apparatus according to the first embodiment.

FIG. 3 shows OFF diagnosis of the first output element 41 and second output element 43 along with an elapsed time.

OFF diagnosis is performed for the first output element 41 and the second output element 43 while the first output element 41 is connected to the first control apparatus 50 and the second output element 43 is connected to the second control apparatus 51. A diagnosis time is set according to the response characteristics of the first control apparatus 50 and second control apparatus 51. The diagnosis unit 20b of the MPU 20 performs OFF diagnosis of the first output element 41 and second output element 43 during the diagnosis time.

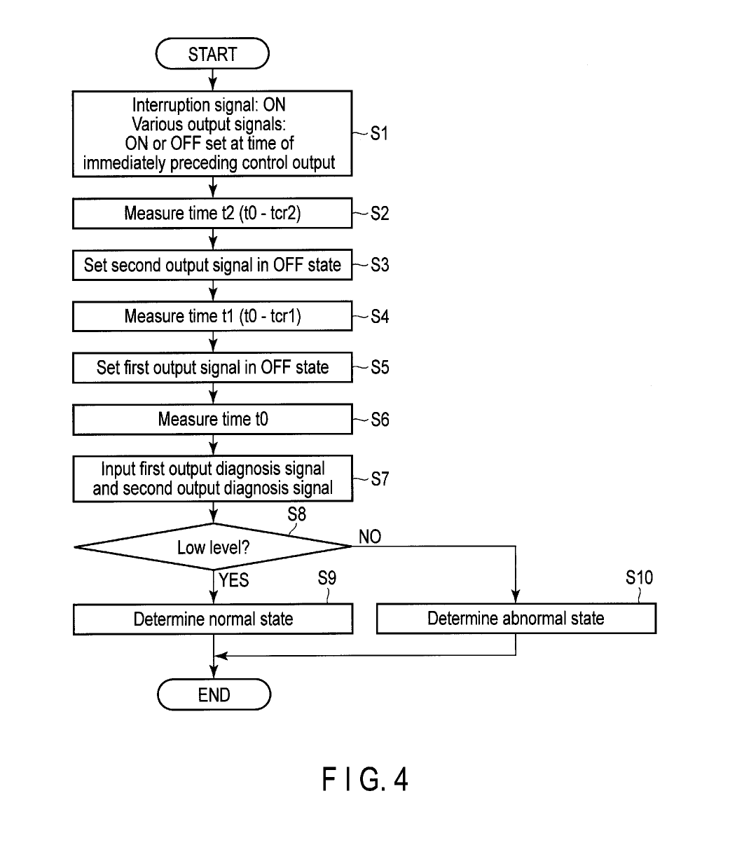

FIG. 4 is a flowchart illustrating an example of a procedure for OFF diagnosis of the first output element 41 and second output element 43 by the output apparatus according to the first embodiment.

In the initial state, before a time t2 a time tcr2 earlier than a diagnosis determination point (detection point) t0 at which OFF diagnosis is performed for the first output element 41 and the second output element 43, the signal control unit 20a of the MPU 20 outputs the first/second interruption signal 101 in the ON state, and causes the driving circuits 21b and 21c to respectively output the first output signal 103 and the second output signal 105 while maintaining the ON or OFF state set at the time immediately preceding control output (step S1).

When the above-described time t2 is measured (step S2), the signal control unit 20a of the MPU 20 outputs a signal for setting the second output signal 105 in the OFF state to the driving circuit 21c for the second output element 43 for OFF diagnosis of the second output element 43 (step S3). This second output signal serves as a driving signal for the second output element 43 on the side of the second control apparatus 51 having a slow response characteristic.

Before a time t1 a time tcr1 earlier than the diagnosis determination point to, the signal control unit 20a of the MPU 20 causes the driving circuit 21b to output the first output signal 103 while maintaining the ON or OFF state set at the time immediately preceding control output.

When the above-described time t1 is measured (step S4), the signal control unit 20a of the MPU 20 outputs a signal for setting the first output signal 103 in the OFF state to the driving circuit 21b for OFF diagnosis of the first output element 41 (step S5). The first output signal 103 serves as a driving signal for the first output element 41 on the side of the first control apparatus 50 having a quick response characteristic.

When the time of the diagnosis determination point t0 is measured (step S6), the diagnosis unit 20b of the MPU 20 inputs the first output diagnosis signal 106 from the first output element 41 and the second output diagnosis signal 107 from the second output element 43 (step S7). After the diagnosis determination point t0, the diagnosis unit 20b of the MPU 20 causes the driving circuit 21a to output the first/second interruption signal 101 while maintaining the ON state, and causes the driving circuits 21b and 21c to respectively output the first output signal 103 and the second output signal 105 while maintaining the ON or OFF state set at the time immediately preceding control output.

If the voltage level of the first output diagnosis signal 106 is low (YES in step S8), the diagnosis unit 20b of the MPU 20 determines that the first output element 41 is in the normal state (step S9). If the voltage level is high (HI) (NO in step S8), the diagnosis unit 20b of the MPU 20 determines that the first output element 41 is in the failure (abnormal) state (step S10). In this way, it is possible to perform OFF diagnosis of the first output element 41. Referring to FIG. 3, a square represents that the detection result indicates the failure state, a circle represents that the detection result indicates the normal state, and a dotted line represents a waveform when the output element is in the failure state.

Similarly, if the voltage level of the second output diagnosis signal 107 is low, the diagnosis unit 20b of the MPU 20 determines that the second output element 43 is in the normal state. If the voltage level is high, the diagnosis unit 20b of the MPU 20 determines that the second output element 43 is in the failure (abnormal) state. In this way, it is possible to perform OFF diagnosis of the second output element 43.

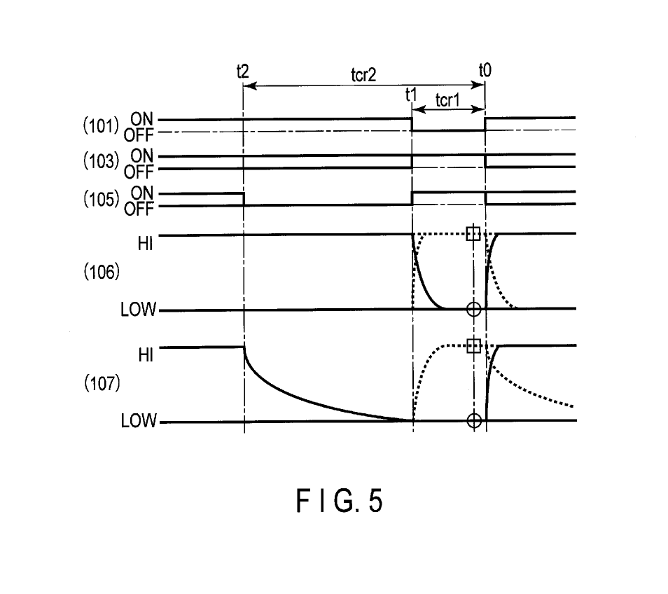

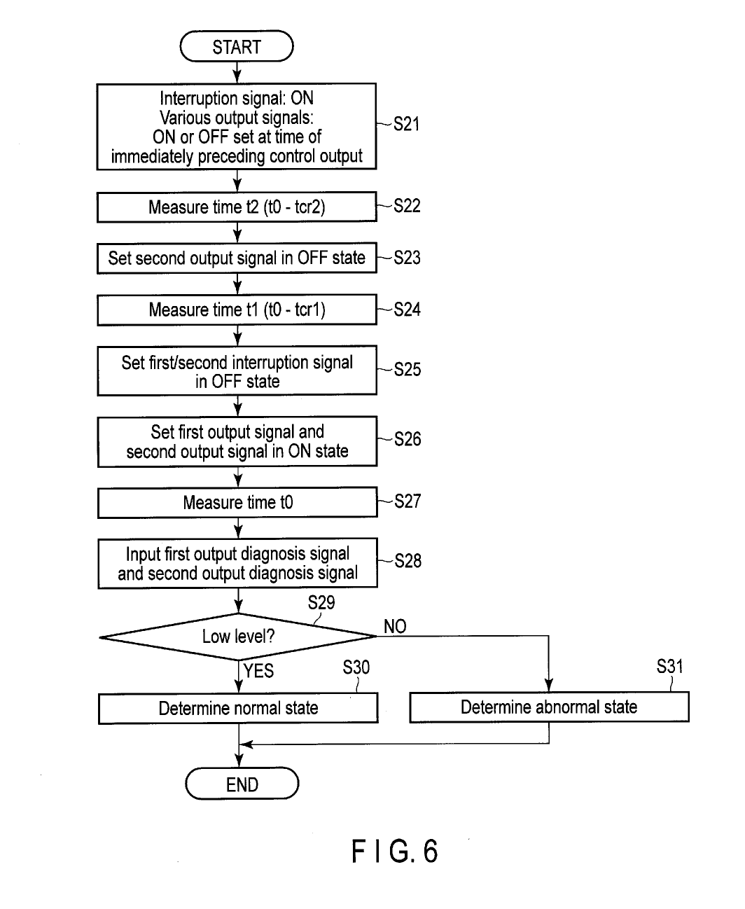

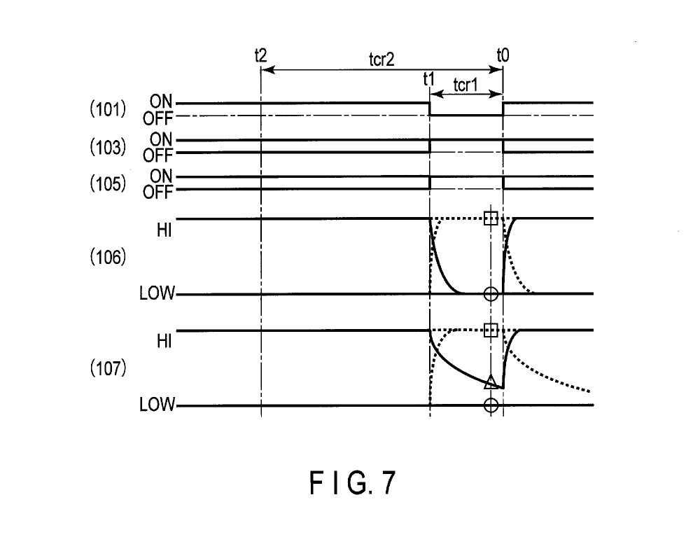

FIG. 5 is a view for explaining an example of an interruption element OFF diagnosis operation by the output apparatus according to the first embodiment. FIG. 6 is a flowchart illustrating an example of a procedure for OFF diagnosis of the first interruption element and second interruption element by the output apparatus according to the first embodiment. FIG. 7 is a view for explaining an example of an interruption element diagnosis operation by the output apparatus according to the first embodiment when the various output signals are ON.

FIGS. 5 and 7 show OFF diagnosis of the first interruption element 40 and second interruption element 42 along with an elapsed time.

In this embodiment, the first interruption element 40 and the second interruption element 42 are collectively controlled. An example of control of the first/second interruption signal 101, first output signal 103, and second output signal 105 will be described with reference to FIG. 7. Before the time t1 the time tcr1 earlier than the diagnosis determination point t0, the signal control unit 20a of the MPU 20 causes the driving circuits 21b and 21c to respectively output the first output signal 103 and the second output signal 105 while maintaining the ON or OFF state set at the time immediately preceding control, as shown in FIG. 7. In this state, by synchronizing the OFF diagnosis timing of each interruption element with the first control apparatus 50 having a quick response characteristic, the signal control unit 20a of the MPU 20 causes the driving circuit 21a to set the first/second interruption signal 101 in the OFF state while causing the driving circuits 21b and 21c to respectively set the first output signal 103 and the second output signal 105 in the ON state at the time t1 the time tcr1 earlier than the diagnosis determination point t0, as shown in FIG. 7. In this case, the first interruption element 40 and the second interruption element 42 perform the same operation.

When, therefore, the second output element 43 is connected to the second control apparatus 51 having a slow response characteristic, if the driving circuit 21c is caused to set the second output signal 105 in the ON state and the driving circuit 21a is caused to set the first/second interruption signal 101 in the OFF state at the time t1 after the time t2 in synchronism with the first control apparatus 50 having a quick response characteristic as described above, the voltage level of the second output diagnosis signal 107 at the diagnosis determination point t0 indicates an intermediate level (uncertain) between low and high levels, as indicated by a triangle in FIG. 7. In this case, the diagnosis unit 20b cannot perform failure diagnosis of the first interruption element 40 and second interruption element 42.

Another example of control of the first/second interruption signal 101 will be described next. Before the time t2 the time tcr2 earlier than the diagnosis determination point t0, the signal control unit 20a of the MPU 20 causes the driving circuits 21b and 21c to respectively output the first output signal 103 and the second output signal 105 while maintaining the ON or OFF state set at the time immediately preceding control. In this state, by synchronizing the OFF diagnosis timing of each interruption element with the second control apparatus 51 having a slow response characteristic, the signal control unit 20a of the MPU 20 causes the driving circuit 21a to set the first/second interruption signal 101 in the OFF state while causing the driving circuits 21b and 21c to respectively set the first output signal 103 and the second output signal 105 in the ON state at the time t2 the time tcr2 earlier than the diagnosis determination point t0. Under such control, however, the time during which the first/second interruption signal 101 is in the OFF state becomes long, and thus the first control apparatus 50 having a quick response characteristic may detect the OFF state of the first output element 41 to cause a malfunction.

To solve this problem, in this embodiment, to change the first or second output signal from the OFF state to the ON state, OFF diagnosis of each interruption element is performed using the characteristic that the response time of the first or second control apparatus as an output destination is short. Furthermore, in this embodiment, to change the first or second output signal from the ON state to the OFF state, OFF diagnosis of each interruption element is performed using the characteristic that the response time of the first or second control apparatus as an output destination is long.

As shown in FIG. 5, in this embodiment, the second output signal 105 is set in the OFF state at the time t2 the time tcr2 earlier than the diagnosis determination point t0. The time t2 is earlier than the time t1, at which the first/second interruption signal 101 is set in the OFF state, by the response time of the second control apparatus 51.

Control will be explained again from a point before the time t2. Before the time t2, the signal control unit 20a of the MPU 20 sets the first/second interruption signal 101 in the ON state via the driving circuit 21a, and causes the driving circuits 21b and 21c to respectively output the first output signal 103 and the second output signal 105 while maintaining the ON or OFF state set at the time immediately preceding control output (step S21).

When the time t2 is measured (step S22), the signal control unit 20a of the MPU 20 outputs a signal for setting the second output signal 105 in the OFF state to the driving circuit 21c (step S23).

Before the time t1, the signal control unit 20a of the MPU 20 causes the driving circuit 21b to output the first output signal 103 while maintaining the ON or OFF state set at the time immediately preceding control output, similarly to the processing before the time t2.

When the time t1 is measured (step S24), the signal control unit 20a of the MPU 20 outputs a signal for setting the first/second interruption signal 101 in the OFF state to the driving circuit 21a (step S25), and also outputs a signal for setting the first output signal 103 and the second output signal 105 in the ON state to the driving circuits 21b and 21c (step S26).

When the diagnosis determination point t0 is measured (step S27), the diagnosis unit 20b of the MPU 20 inputs the first output diagnosis signal 106 and the second output diagnosis signal 107 (step S28). After the diagnosis determination point t0, the diagnosis unit 20b of the MPU 20 outputs a signal for setting the first/second interruption signal 101 in the ON state to the driving circuit 21a, and also causes the driving circuits 21b and 21c to respectively output the first output signal 103 and the second output signal 105 while maintaining the ON or OFF state set at the time immediately preceding control output.

If the voltage level of the first output diagnosis signal 106 is low (YES in step S29), the diagnosis unit 20b of the MPU 20 determines that the first interruption element 40 is in the normal state (step S30). If the voltage level is high (NO in step S29), the diagnosis unit 20b of the MPU 20 determines that the first interruption element 40 is in the failure (abnormal) state (step S31). Referring to FIG. 5, a square represents that the detection result indicates the failure state, a circle represents that the detection result indicates the normal state, and a dotted line represents a waveform when the output element is in the failure state.

If the voltage level of the second output diagnosis signal 107 is low, the diagnosis unit 20b of the MPU 20 determines that the second interruption element 42 is in the normal state. If the voltage level is high, the diagnosis unit 20b of the MPU 20 determines that the second interruption element 42 is in the failure (abnormal) state.

As described above, the first output signal 103 and the second output signal 105 are conventionally set in the ON state at the same predetermined timing for OFF diagnosis of the first interruption element 40 and second interruption element 42. To the contrary, in this embodiment, the MPU 20 outputs signals for setting the first output signal 103 and second output signal 105 in the OFF state at different timings, according to the response characteristic of each control apparatus.

More specifically, at a timing earlier than the diagnosis determination point t0 by the response time of the second control apparatus 51, the MPU 20 sets, in the OFF state, the second output signal 105, of the various output signals, which concerns the second control apparatus 51 having a slow response characteristic. After that, the MPU 20 sets the second output signal 105 in the ON state at an early timing according to the response time of the first control apparatus 50 having a quick response characteristic. This can prevent the voltage level of the output signal concerning the second control apparatus 51 having a slow response characteristic from becoming an intermediate level at the diagnosis determination point to.

At a timing earlier by the response time of the control apparatus having a quick response characteristic, the MPU 20 sets, in the ON state, the output signal, of the various output signals, which concerns the control apparatus. This eliminates the need to set the first/second interruption signal 101 in the OFF state at an unnecessarily early timing. It is, therefore, possible to prevent the first control apparatus 50 having a quick response characteristic from detecting the OFF state of the first output element 41 to cause a malfunction when the time during which the first/second interruption signal 101 is in the OFF state becomes long.

Even if one common driving circuit is used as driving circuits as the driving circuit for various interruption elements, it is possible to correctly perform OFF diagnosis of the first interruption element 40 and second interruption element 42 based on the voltage levels of the first output diagnosis signal 106 and second output diagnosis signal 107 at the diagnosis determination point t0 of the first interruption element 40 and second interruption element 42.

That is, it is possible to ensure the time for diagnosing the respective interruption elements collectively according to the response characteristic of each control apparatus, and diagnose the respective interruption elements collectively according to the response characteristic of the load of each digital output circuit.

### Second Embodiment

The second embodiment of the present invention will be described next. Note that, of the functions of an output apparatus according to this embodiment, the same functions as those shown in FIG. 1 are denoted by the same reference numerals, and a description thereof will be omitted. Different functions will be mainly explained.

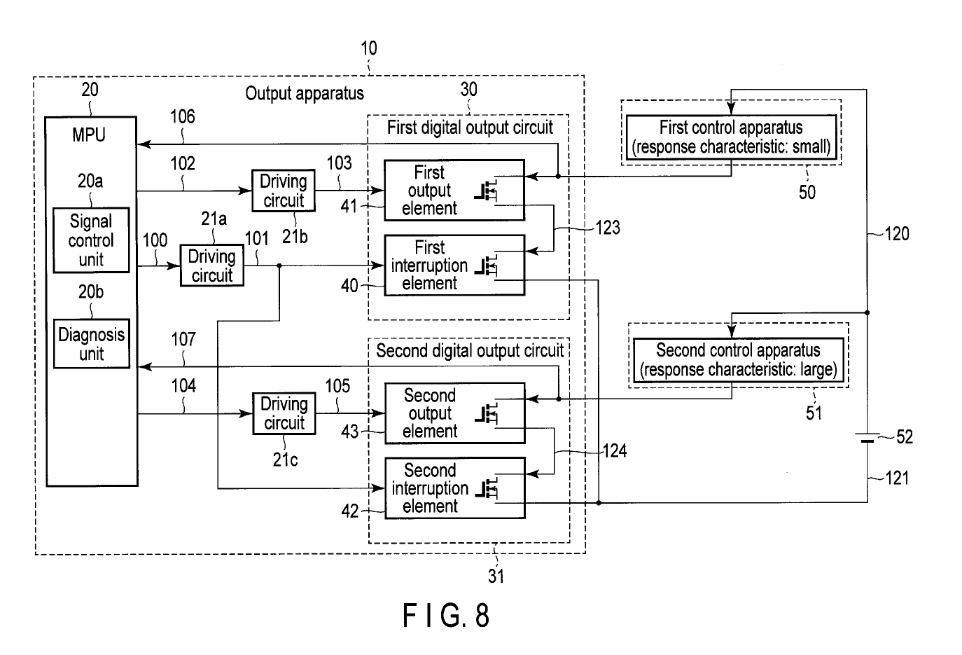

FIG. 8 is a circuit diagram showing an example of the arrangement of the digital output circuits of the output apparatus according to the second embodiment.

The connection configuration between various driving circuits 21a, 21b, and 21c and the first digital output circuit 30 and second digital output circuit 31 of an output apparatus 10 is the same as that shown in FIG. 1.

The arrangement shown in FIG. 8 is an arrangement in which a so-called sink-driving control apparatus serves as a load. A difference from the arrangement shown in FIG. 1 is that the sources of a first interruption element 40 and second interruption element 42 are connected to the negative side of an external power supply apparatus 52 via a negative line 121 of the external power supply apparatus.

The positive side of the external power supply apparatus 52 is connected to the input terminals of a first control apparatus 50 and second control apparatus 51 via a positive line 120 of the external power supply apparatus.

The output terminal of the first control apparatus 50 is connected to an MPU 20 and the drain of a first output element 41. That is, a first output diagnosis signal 106 is output from the first control apparatus 50.

The output terminal of the second control apparatus 51 is connected to the MPU 20 and the drain of a second output element 43. That is, a second output diagnosis signal 107 is output from the second control apparatus 51.

The source of the first output element 41 is connected to the drain of the first interruption element 40 via a first interruption element-first output element connection line 123. That is, the connection relationship between the first output element 41 and the first interruption element 40 is reversed with respect to the arrangement shown in FIG. 1.

The source of the second output element 43 is connected to the drain of the second interruption element 42 via a second interruption element-second output element connection line 124. That is, the connection relationship between the second output element 43 and the second interruption element 42 is reversed with respect to the arrangement shown in FIG. 1.

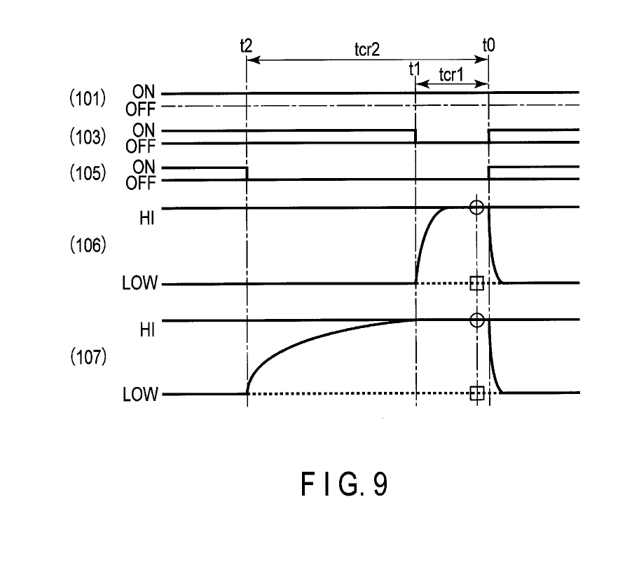

FIG. 9 is a view for explaining an example of an output element diagnosis operation by the output apparatus according to the second embodiment.

FIG. 9 shows OFF diagnosis of the first output element 41 and second output element 43 along with an elapsed time.

Similarly to the first embodiment, a control apparatus having a quick response characteristic, for example, a small time constant (tcr1<tcr2) is used as the first control apparatus 50 connected to the first output element 41 of the first digital output circuit 30. A control apparatus having a slow response characteristic, for example, a large time constant (tcr2>tcr1) is used as the second control apparatus 51 connected to the second output element 43 of the second digital output circuit 31.

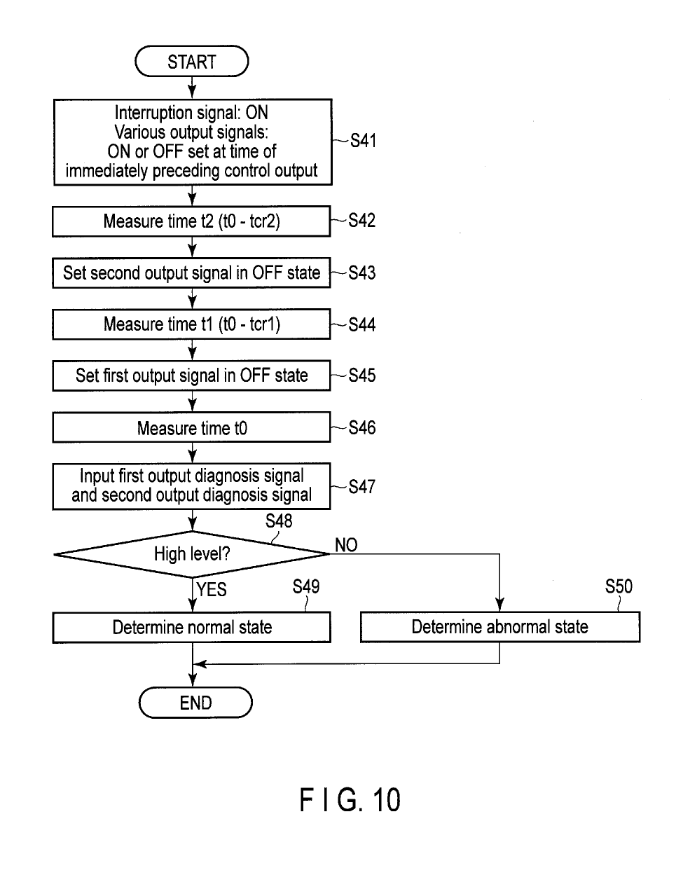

FIG. 10 is a flowchart illustrating an example of a procedure for OFF diagnosis of the first output element and second output element by the output apparatus according to the second embodiment.

The control processes of various signals in steps S1 to S5 described in the first embodiment when a time t2 the time tcr2 earlier than a diagnosis determination point t0 is measured and when a time t1 the time tcr1 earlier than the diagnosis determination point t1 is measured are performed (step S41 to S45).

When the time of the diagnosis determination point t0 is measured (step S46), a signal control unit 20a of the MPU 20 inputs the voltage level of the first output diagnosis signal 106 from the first control apparatus 50, and the second output diagnosis signal 107 from the second control apparatus 51 (step S47).

If the voltage level of the first output diagnosis signal 106 is high (YES in step S48), a diagnosis unit 20b of the MPU 20 determines that the first output element 41 is in the normal state (step S49). If the voltage level is low (NO in step S48), the diagnosis unit 20b of the MPU 20 determines that the first output element 41 is in the failure (abnormal) state (step S50).

Similarly, if the voltage level of the second output diagnosis signal 107 is high, the diagnosis unit 20b of the MPU 20 determines that the second output element 43 is in the normal state. If the voltage level is low, the diagnosis unit 20b of the MPU 20 determines that the second output element 43 is in the failure (abnormal) state. Referring to FIG. 9, a square represents that the detection result indicates the failure state, a circle represents that the detection result indicates the normal state, and a dotted line represents a waveform when the output element is in the failure state.

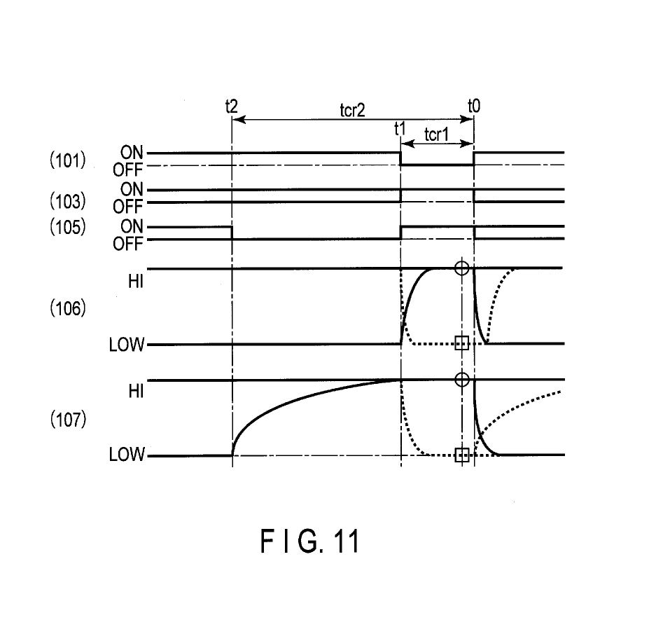

FIG. 11 is a view for explaining an example of an interruption element diagnosis operation by the output apparatus according to the second embodiment.

FIG. 11 shows OFF diagnosis of the first interruption element 40 and second interruption element 42 along with an elapsed time.

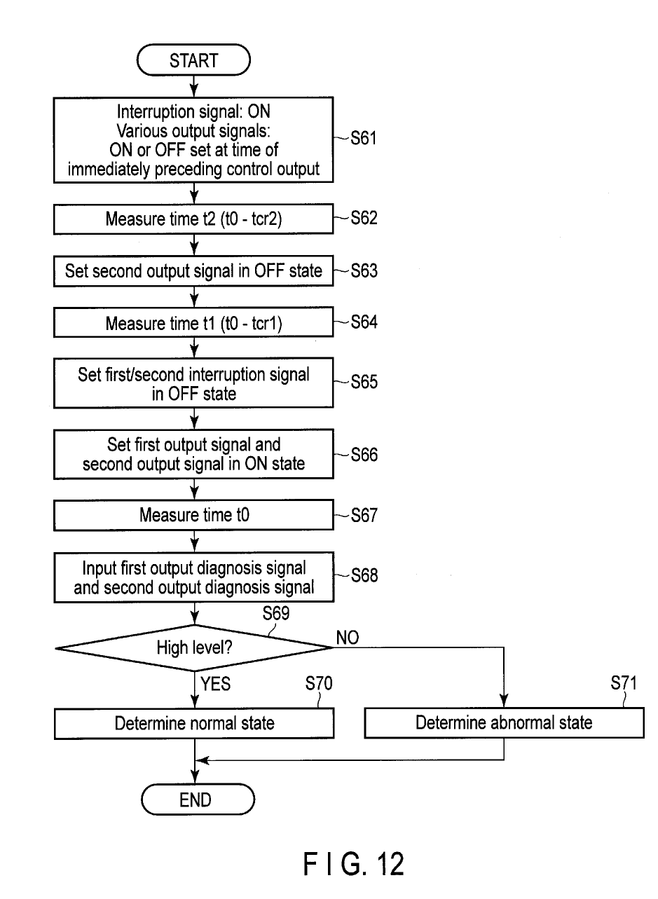

FIG. 12 is a flowchart illustrating an example of a procedure for OFF diagnosis of the first interruption element and second interruption element by the output apparatus according to the second embodiment.

The control processes of the various signals in steps S21 to S26 described in the first embodiment when the time t2 the time tcr2 earlier than the diagnosis determination point t0 is measured and when the time t1 the time tcr1 earlier than the diagnosis determination point t0 is measured are performed (step S61 to S66).

When the diagnosis determination point t0 is measured (step S67), the diagnosis unit 20b of the MPU 20 inputs the first output diagnosis signal 106 and the second output diagnosis signal 107 (step S68).

If the voltage level of the first output diagnosis signal 106 is high (YES in step S69), the diagnosis unit 20b of the MPU 20 determines that the first interruption element 40 is in the normal state (step S70). If the voltage level is low (NO in step S69), the diagnosis unit 20b of the MPU 20 determines that the first interruption element 40 is in the failure (abnormal) state (step S71).

Similarly, if the voltage level of the second output diagnosis signal 107 is high, the diagnosis unit 20b of the MPU 20 determines that the second interruption element 42 is in the normal state. If the voltage level is low, the diagnosis unit 20b of the MPU 20 determines that the second interruption element 42 is in the failure (abnormal) state (step S71). Referring to FIG. 11, a square represents that the detection result indicates the failure state, a circle represents that the detection result indicates the normal state, and a dotted line represents a waveform when the output element is in the failure state.

As described above, according to the second embodiment, even the arrangement using sink driving makes it possible to obtain the same effects as those in the first embodiment.

Note that the method described in each of the aforementioned embodiments can be stored in a storage medium such as a magnetic disk (a Floppy® disk, a hard disk, or the like), an optical disk (a CD-ROM, a DVD, or the like), a magnetooptical disk (MO), or a semiconductor memory as a program executable by a computer, and can be distributed.

Any storage format may be adopted as long as the storage medium can store a program, and is readable by the computer.

An OS (Operating System) operating on the computer, MW (middleware) such as database management software or network software, or the like may execute part of each process for implementing the aforementioned embodiments based on the instruction of the program installed from the storage medium to the computer.

The storage medium according to each of the embodiments is not limited to a medium independent of the computer, and also includes a storage medium that stores or temporarily stores the program transmitted by a LAN, the Internet, or the like by downloading it.

The number of storage media is not limited to one. The storage medium according to the present invention also incorporates a case in which the processing of each of the aforementioned embodiments is executed from a plurality of media, and the media can have any arrangement. Note that the computer according to each of the embodiments is configured to execute each process of each of the aforementioned embodiments based on the program stored in the storage medium, and may be, for example, a single device formed from a personal computer or a system including a plurality of devices connected via a network.

The computer according to each of the embodiments is not limited to a personal computer, and also includes an arithmetic processing device or microcomputer included in an information processing apparatus. The term “computer” collectively indicates apparatuses and devices capable of implementing the functions of the present invention by the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An output apparatus connected to a first load and a second load whose response time to a signal is longer than that of the first load, comprising:
a first digital output circuit including a first output element configured to output a signal to the first load, and a first interruption element connected to the first output element;
a second digital output circuit including a second output element configured to output a signal to the second load, and a second interruption element connected to the second output element;
a single driving circuit for an interruption element, configured to drive the first interruption element and the second interruption element collectively;
a signal control unit configured to set a signal from the second output element in an OFF state at a timing earlier than a predetermined timing by the response time of the second load, and set signals from the first output element and the second output element in an ON state, and signals from the first interruption element and the second interruption element in an OFF state at a timing earlier than the predetermined timing by the response time of the first load; and
a diagnosis unit configured to diagnose, at the predetermined timing, whether the first interruption element is in a normal state or a failure state, based on a signal from the first digital output circuit, and diagnose, at the predetermined timing, whether the second interruption element is in a normal state or a failure state, based on a signal from the second digital output circuit.

2. The apparatus according to claim 1, wherein
the first interruption element, the second interruption element, the first output element, and the second output element are field effect transistors,
the driving circuit is connected to gates of the first interruption element and second interruption element,
a source of the first interruption element is connected to a drain of the first output element,
a source of the second interruption element is connected to a drain of the second output element,
the first load includes an input terminal connected to a source of the first output element, and an output terminal connected to drains of the first interruption element and second interruption element,
the second load includes an input terminal connected to a source of the second output element, and an output terminal connected to drains of the first interruption element and second interruption element, and
at the predetermined timing, the diagnosis unit diagnoses, based on a signal from the first output element, whether the first interruption element is in the normal state or the failure state, and diagnoses, based on a signal from the second output element, whether the second interruption element is in the normal state or the failure state.

3. The apparatus according to claim 1, wherein
the first interruption element, the second interruption element, the first output element, and the second output element are field effect transistors,
the driving circuit is connected to gates of the first interruption element and second interruption element,
a source of the first output element is connected to a drain of the interruption element,
a source of the second output element is connected to a drain of the second interruption element,
the first load includes an input terminal connected to sources of the first interruption element and second interruption element, and an output terminal connected to a drain of the first output element,
the second load includes an input terminal connected to sources of the first interruption element and second interruption element, and an output terminal connected to a drain of the second output element, and
the diagnosis unit diagnoses, at the predetermined timing, whether the first interruption element is in the normal state or the failure state, based on a signal from the first load, and diagnoses, at the predetermined timing, whether the second interruption element is in the normal state or the failure state, based on a signal from the second load.

4. A diagnosis method for an output apparatus connected to a first load and a second load whose response time to a signal is longer than that of the first load, and including a first digital output circuit with a first output element configured to output a signal to the first load and a first interruption element connected to the first output element, a second digital output circuit with a second output element configured to output a signal to the second load and a second interruption element connected to the second output element, and a single driving circuit for an interruption element, configured to drive the first interruption element and the second interruption element collectively, the method comprising:
setting a signal from the second output element in an OFF state at a timing earlier than a predetermined timing by the response time of the second load, and setting signals from the first output element and the second output element in an ON state, and signals from the first interruption element and the second interruption element in an OFF state at a timing earlier than the predetermined timing by the response time of the first load; and
diagnosing, at the predetermined timing, whether the first interruption element is in a normal state or a failure state, based on a signal from the first digital output circuit, and diagnosing, at the predetermined timing, whether the second interruption element is in a normal state or a failure state, based on a signal from the second digital output circuit.
